(19) United States
(12) Patent Application Publication
(10) Pub. No.: US 2026/0110617 A1
(43) Pub. Date: Apr. 23, 2026

(54) DEVICE FOR DETECTING AND EVALUATING PARTICLES

(71) Applicant: Kurz Elektronik GmbH, Althengstett (DE)

(72) Inventors: Christian Meyer, Gechingen (DE); Detlef Schulz, Althengstett (DE)

(21) Appl. No.: 19/486,735

(22) PCT Filed: Mar. 21, 2024
(86) PCT No.: PCT/EP2024/057659

§ 371 Date: Nov. 21, 2025

(30) Foreign Application Priority Data
May 22, 2023 (DE) 10 2023 113 321.7

(51) Int. Cl. G01N 15/1429; A47L 9/24; A47L 9/28; G01N 15/14

(52) U.S. Cl. CPC G01N 15/1431; A47L 9/248; A47L 9/2815; A47L 9/2842; A47L 9/2894; G01N 15/1459; A47L 2201/06; G01N 2015/1493

(57) ABSTRACT

A device for detecting and evaluating particles, particularly in a suction stream of a vacuum cleaner, comprising a light source designed to emit a light beam along an optical path and through a measuring space; and a light sensor designed to receive the light beam after it has passed through the measuring space, wherein the light sensor emits an analog measurement signal. An analog-to-digital converter is designed to convert the analog measurement signal into time-discrete digital measured values; a buffer memory is designed to buffer a predefined number of measured values; a frequency evaluation apparatus is connected to the buffer memory and a transmission apparatus designed to provide a digital output signal from the frequency evaluation apparatus at a digital output as a digital output value for transmission.

### CROSS-REFERENCE TO RELATED APPLICATIONS

This is a national stage application of International patent application PCT/EP2024/057659, filed Mar. 21, 2024, which claims the priority of German patent application DE 10 2023 113 321.7, filed May 22, 2023. Both application PCT/EP2024/057659 and DE 10 2023 113 321.7 are hereby incorporated by reference in their entireties.

### FIELD

The present invention generally relates to a device for detecting and evaluating particles, in particular in a suction stream of a vacuum cleaner, comprising a light source, in particular an infrared LED, which is designed to emit a light beam along an optical path and through a measuring space, and a light sensor which is designed to receive the light beam after it has passed through the measuring space, wherein the light sensor emits an analog measurement signal. Furthermore, the invention generally relates to a method for detecting and evaluating particles. Finally, the invention generally relates to a vacuum cleaner comprising such a device.

### BACKGROUND

In the past, the applicant has used various dust sensors in vacuum cleaners that detect the amount of particles in the suction stream (i.e. suction airflow) of a vacuum cleaner and then display this to the user. In so doing, as a rule, analog evaluation circuits with direct control of an LED were used. An optically operating dust sensor is known, for example, from DE 38 03 824 C2.

In addition to optically functioning dust sensors, sensors are also on the market that use piezoelectric components for dust detection. DE 102009005598 A1 discloses such a dust sensor and an evaluation circuit for evaluating the measurement signal. One of the disadvantages of these dust sensors can be considered to be that they are located in the suction stream and thereby obstruct it. In addition, sucked-in particles can get caught on the dust sensor, for example, and thereby further hinder the suction stream. Finally, the measurement result of these dust sensors is not independent of the suction power, with low suction powers tending to lead to poorer measurement results. This would be disadvantageous, for example, when used in so-called robot vacuum cleaners since these work with small batteries and therefore have to be operated with lower suction power.

Although the previous solutions have proven themselves in practice in a few areas of application, they lack flexibility with regard to a wider, more comprehensive area of use. In addition, they are expensive and difficult to integrate into modern digital systems.

Against this background, an object of the present application is to further develop a device of the type mentioned at the outset in such a way that it can be manufactured economically and flexibly adapted to different areas of use.

### SUMMARY

This object may be achieved by the device defined in claim 1 for detecting and evaluating particles, in particular in a suction stream of a vacuum cleaner.

The device according to one example comprises: an analog-to-digital converter that is designed to convert the analog measurement signal into time-discrete digital measured values; a buffer memory that is designed to buffer a predefined number of measured values; a frequency evaluation apparatus that is connected to the buffer memory and has: a frequency transformation apparatus that is designed to break down the time-discrete measured values from the buffer memory into frequency spectrum values of a predefined number n1 of frequency ranges; and a first weighting and summing apparatus that is designed to multiply each of the number of n1 frequency spectrum values by a first weighting value and to add the weighted n1 frequency spectrum values so that a first weighted sum value is obtained; and a transmission apparatus that is designed to provide a digital output value of the frequency evaluation apparatus at a digital output for transmission.

The device has the advantage that it is economical due to the digital design and can be flexibly installed in different vacuum cleaners. The signal is evaluated completely digitally, so that the evaluation process can be very easily adapted using freely programmable parameters. The result of the evaluation is provided by the transmission apparatus in digital form, so that another control apparatus, e.g. in a vacuum cleaner, can take the result and use it for further control purposes.

In addition, by evaluating different frequency ranges, an evaluation of the size of the particles can be made, wherein the weighting allows adaptation to the area of use.

The object is thus fully achieved.

In a preferred further development, the frequency transformation apparatus has a unit for carrying out the Goerzel algorithm.

The advantage of this algorithm is that it requires less computing power than, for example, an FFT (fast Fourier transform) method.

In a preferred development, the n1 first weighting values are adjustable.

This has the advantage that flexibility and adaptability are improved.

In a preferred development, a first low-pass filter is provided to which the first weighted sum value is supplied.

This measure has the advantage that a certain smoothing and therefore improvement of the evaluation result is possible.

In a preferred development, the device has an amplitude evaluation apparatus which is connected on the input side to the buffer memory, wherein the amplitude evaluation apparatus has:
a differentiation unit which determines the maximum and the minimum value of the values saved in the buffer memory and generates a difference value therefrom,
a first filter array with a number of n2 low-pass filters arranged in parallel with different time constants, each of which is supplied with the difference value, and
a second weighting and summing apparatus that is designed to receive the individual values from the n2 low-pass filters, to multiply each of the filtered values by a second weighting value, and to sum the weighted values to form a summed difference value.

The amplitude evaluation apparatus leads to a further improvement of the evaluation result. By evaluating the amplitude values, changes in particle sizes can be detected and therefore also represented dynamically. Processing via multiple parallel low-pass filters also allows for a temporal classification of these changes, i.e. within which time periods the changes occur.

In a preferred development, the time constants of the low-pass filters in the first filter array can be changed in powers of two.

This measure has proven to be particularly advantageous.

In a preferred further development, the number of n2 second weighting values can be adjusted.

This measure increases the flexibility of the device, i.e. its adaptability to different areas of application.

In a preferred development, an integral evaluation apparatus is provided which is connected on the input side to the buffer memory, wherein the integral evaluation apparatus has:
a summing unit which generates the sum of the absolute values of the difference between a value in the buffer memory and the average value of all values in the buffer memory as an integral value,
a second filter array with a number of n3 low-pass filters arranged in parallel with different time constants, each of which is supplied with the integral value, and
a third weighting and summing apparatus that is designed to receive the individual values from the n3 low-pass filters of the second filter array, to multiply each of the received values by a third weighting value, and to sum the weighted values to form a summed integral value.

This measure has the advantage of further increasing the evaluation options. The integral evaluation apparatus enables the temporal detection of the change in the particle quantity. This makes it possible to determine whether the degree of cleaning of the vacuumed surface is improving or stagnating.

These measures have proven to be particularly advantageous.

In a preferred development, the time constants of the low-pass filters in the second filter array change in powers of two. Further preferably, the number of n3 third weighting values is adjustable.

In a preferred development, a fourth weighting and summing apparatus is provided, to which the values from the frequency evaluation apparatus, the amplitude evaluation apparatus and the integral evaluation apparatus are supplied, and which is designed to multiply each of the supplied values by a fourth weighting value and to sum the weighted values to form a total output value.

This measure allows further adaptability of the evaluation. Different evaluations can be weighted differently in the output.

In a preferred development, a first operational amplifier and a second operational amplifier are provided, wherein the first operational amplifier controls the light source and the second operational amplifier is connected on the input side to the light sensor and outputs the analog measurement signal on the output side. Preferably, the signal from the light sensor is supplied to the first operational amplifier which, on the basis this signal, controls the light source with a control signal such that the signal from the light sensor has a predefined value when the path is clear.

This measure has the advantage that the operating point is adjusted in a controlled manner, so that the measurement is independent of dirt.

In a preferred development, a monitoring unit is provided which is designed to monitor the control signal and to signal that the control signal has exceeded a predetermined, in particular predefinable, value. Preferably, a reporting signal is transmitted to the transmission apparatus.

This measure has the advantage that a warning can be issued if the device can no longer set the operating point correctly, e.g. due to excessive dirt.

An object underlying the present application may also be achieved by a method as defined in claim 19.

The advantages correspond to those of the aforementioned device.

Finally, the object may also be achieved by a cleaning device, in particular a vacuum cleaner, as defined in claim 22.

It is particularly advantageous to use the device according to the present application in a robot vacuum cleaner. The digital output value provided by the device as a result of the evaluation can be used by a control system of the suction motor and/or of the drive. For example, on the basis of the degree of cleaning of the vacuumed surface, certain surfaces could be targeted multiple times, or other already cleaned surfaces could be removed from the area to be traveled over.

It is understood that the features mentioned above and those to be explained below can be used not only in the combination specified in each case, but also in other combinations or on their own without departing from the scope of the present invention.

### DRAWINGS

Further advantages and embodiments are apparent from the description and the accompanying drawings, in which:

FIG. 1 is a block diagram of a vacuum cleaner with the components relevant to the present application;

FIG. 2 is a block diagram of a device according to the present application for detecting and evaluating particles in a suction stream of a vacuum cleaner;

FIG. 3 is a block diagram of a frequency evaluation apparatus;

FIG. 4 is a block diagram of an amplitude evaluation apparatus,

FIG. 5 is a block diagram of an integral evaluation apparatus; and

FIG. 6 is a block diagram of a robot vacuum cleaner with a device according to the present application.

### DETAILED DESCRIPTION

The device for detecting and evaluating particles in a gaseous stream, which is explained in detail below, substantially serves as a flexibly adjustable, dynamic display of the quantity and the quality of the particles present in the gaseous stream. In particular, the change over time in the quantity and quality of the particles is to be detected and represented. The device is used in particular in vacuum cleaners to detect and appropriately represent the quality and quantity of dust particles in the sucked-in air.

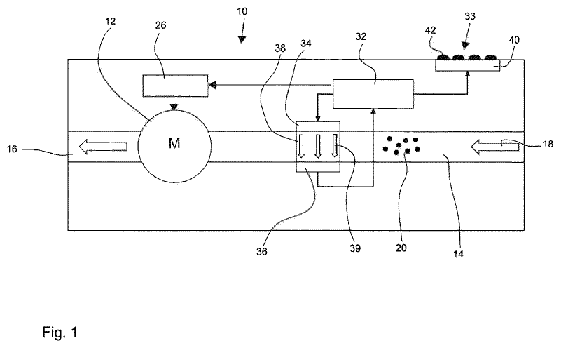

In FIG. 1, a block diagram is represented that shows the components of a vacuum cleaner 10 relevant to the invention. The vacuum cleaner 10 can be, for example, a handheld vacuum cleaner, a floor vacuum cleaner or a robot vacuum cleaner. The vacuum cleaner 10 has a motor 12 which sucks in air through a nozzle (not shown) by means of a suction pipe 14 and blows it out again through an exhaust pipe 16. The sucked-in air 18 is a mixture of particles, in particular dust particles 20, and air, with this mixture usually being referred to as a 2-phase flow or 2-phase mixture. The motor 12 is controlled, for example, by a higher-level control apparatus 26 in order to adjust the power of the motor 14, for example. This higher-level control apparatus 26 can also assume other open-loop and closed-loop control tasks in a vacuum cleaner.

The 2-phase flow typically passes through a collecting container (not shown) which filters the dust particles from the mixture and then blows out the substantially particle-free air via the exhaust pipe 16.

In order to detect the particles 20 in the 2-phase flow 18, a device 30 is provided which comprises a measuring apparatus 31 and a circuit 32. The measuring apparatus 31 is assigned to a section of the suction pipe 14 and comprises a light source 34 on one side and a light sensor 36 on the other side, which are aligned with one another so that an optical path 39 through which a light beam travels arises between the light source 34 and the light sensor 36. This optical path 39 lies within the suction pipe 14, so that this portion of the suction pipe serves as a measuring space 38. Preferably, the light source and light sensor lie behind translucent but dust-tight and/or gas-tight cutouts/windows in the suction pipe 14. The 2-phase mixture flowing through this measuring space 38 changes the amount of light arriving at the light sensor 36, which can be measured and evaluated and allows a conclusion about the degree of cleaning of the vacuumed surface or how the degree of cleaning is currently changing. Since the light sensor lies outside the measuring space, the flow through the sensor is not affected.

The circuit 32 controls the light source 34, which is preferably designed as an infrared LED 35, and the light sensor 36, which is preferably designed as a photodiode 37, returns the measurement signal to the circuit 32 for evaluation.

A result of the evaluation of the received measurement signal is then transmitted by the circuit 32, for example, to an output apparatus 33 which has a display apparatus 40, for example with LEDs 42, for the optical representation of the evaluation result. At this point, however, it should be noted that, alternatively or in addition to the optical display apparatus 40, an acoustic reproduction of the result can also be carried out.

The result output optically/acoustically is intended to provide the user of the vacuum cleaner with, inter alia, information about the degree of dirt or the degree of cleaning of the vacuumed surface, and/or information about how the degree of cleaning changes over time.

Alternatively or additionally, the result of the evaluation is transmitted to the higher-level control apparatus 26 of the vacuum cleaner 10, which can, for example, control the power of the motor 12 depending on the result of the evaluation.

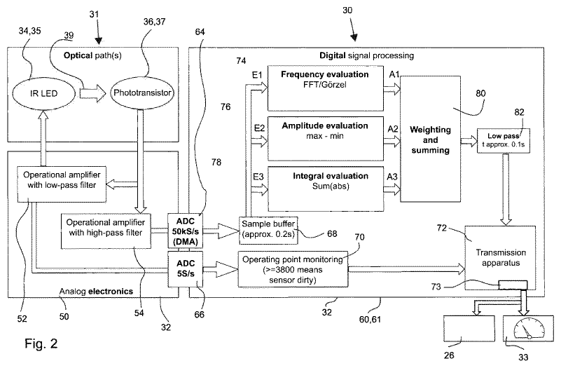

The device 30 is shown schematically in FIG. 2 in the form of a block diagram. The measuring apparatus 31 with the infrared LED 35 (IR-LED) and the phototransistor 37 and the circuit 32 can be seen therein, which in the present embodiment has an analog circuit part 50 and a digital circuit part 60. The digital circuit part 60 can be provided in a controller 61.

The analog circuit part 50 of the circuit 32 comprises a first operational amplifier 52 with a low-pass filter which adjusts the infrared LED 35 to the desired operating point. The phototransistor 37 supplies the measurement signal to a second operational amplifier 54 with high pass, as well as to the first operational amplifier 52. The second operational amplifier 54 has a high gain factor to provide the useful signal from the phototransistor with high dynamics. The measurement signal provided by the second operational amplifier 54 is supplied to an analog-to-digital converter 64 which provides digital signals or second discrete digital values at the output with a sampling rate of 50,000 samples per second, for example.

The signal generated by the first operational amplifier 52, which is supplied to the infrared LED 35 and determines its brightness, is also transmitted to a second analog-to-digital converter 66 which generates a digital signal or time-discrete digital values at a sampling rate of 5 samples per second.

The feedback of the measurement signal from the phototransistor 37 to the first operational amplifier 52 serves to adjust the operating point of the infrared LED 35. In other words, the first operational amplifier is designed in such a way that a predetermined light intensity/amount of light always reaches the phototransistor 37 (wherein no particles should be in the measuring space when setting the operating point). The supplied measurement signal is smoothed via the low-pass filter in the first operational amplifier, so that short-term fluctuations in the measurement signal have no influence on the setting of the operating point.

This control of the operating point prevents dirt in the area of the optical path, for example at the translucent cuts in the suction pipe, from having an influence on the measurement.

The digital circuit part 60 comprises the two analog-to-digital converters 64, 66 as well as further digital functional elements which are explained below.

The second analog-to-digital converter 66, to which the control signal for the IR LED 35 is supplied, supplies the digital signal or the digital values to an operating point monitoring apparatus 70 which compares the digital values with a predetermined, in particular adjustable, threshold value. If this threshold value is reached or exceeded, this indicates that, for example, the areas in front of the phototransistor 37 or the IR LED 35 are dirty. The operating point monitoring apparatus 70 delivers a warning signal when the predetermined threshold value is reached or exceeded to a transmission apparatus 72 which processes the warning signal and feeds it to the control apparatus 26 and/or the output apparatus 33 via a digital interface 73. The output apparatus 33 can then, for example, visually and/or acoustically inform the user of the vacuum cleaner 10 that the measuring space 38 should be cleaned.

The first analog-to-digital converter 64 supplies the digital measurement signals, i.e. measured values, to a buffer memory 68 which is preferably designed as a ring memory. This buffer memory 68 saves the time-discrete digital measured values, for example, within a time window of 0.2 seconds, i.e. with a sampling rate of 50,000 samples per second, there are 10,000 measured values in the buffer memory 68. Since the buffer memory 68 is designed as a ring memory, the oldest measured value drops out of the buffer memory 68 when a new measured value supplied by the analog-to-digital converter 64 is saved. The time window therefore shifts by one value with each sampling.

At this point, however, it should be noted that the mentioned sampling rate and the size of the buffer memory are example values that can also be selected differently depending on the application.

On the basis of the measured values saved in the buffer memory 68, three different evaluations are carried out, namely a frequency evaluation, an amplitude evaluation and an integral evaluation. For this purpose, a frequency evaluation apparatus 74, an amplitude evaluation apparatus 76 and an integral evaluation apparatus 78 are provided.

The results of these evaluations are transmitted in the form of digital data A1, A2 and A3 to a weighting and summing apparatus 80 which weights the corresponding data and sums them to form a total value. The sequence of sum values is transmitted to a low-pass filter 82 which carries out a smoothing of the sum values, for example with a time constant of 0.1 seconds, and transmits the smoothed values to the transmission apparatus 72. The transmission apparatus processes the values and outputs them via the interface 73 to the output apparatus 33 and/or to the control apparatus 26. Of course, it would also be conceivable for the control apparatus 26 and/or the output apparatus 33 to retrieve the values independently and when required. The output apparatus 33 can, for example, be designed to dynamically visualize the values, wherein a linear interpolation can be carried out for better representation.

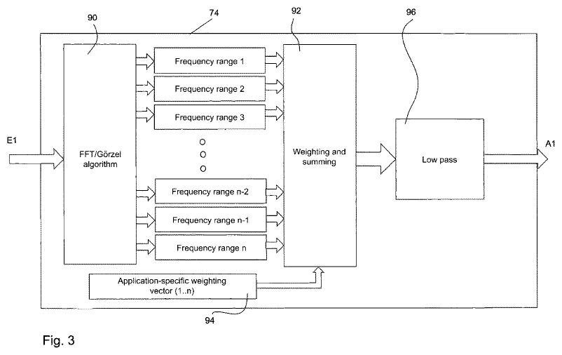

In FIG. 3, the frequency evaluation apparatus 74 is shown in the form of a block diagram. The frequency evaluation apparatus 74 comprises a frequency transformation apparatus 90 which subjects the time-discrete digital values supplied thereto to a frequency transformation and divides them into a number n of frequency ranges. The value n is an integer greater than 0, preferably 16. Consequently, n frequency values are provided at the output of the frequency transformation apparatus 90. Since the conversion of a sequence of time-discrete values into the frequency range is known from a technical point of view, it will not be discussed in further detail. In the present embodiment, for example, a known fast Fourier transform, FFT, method can be used. Alternatively, a so-called Goerzel algorithm could be used which has the advantage that it is less computationally intensive.

The frequency transformation apparatus 90 retrieves the time-discrete values to be converted from the buffer memory 68, wherein preferably all values of the memory are read out and then subjected to a frequency transformation. This means that with a time window of 0.2 seconds, the buffer memory 68 is read out every 0.2 seconds by the frequency transformation apparatus 90. Of course, it would also be conceivable to read out the data from the buffer memory 68 in a different chronological order.

The number of n calculated frequency values for the frequency ranges 1 to n are supplied to a weighting and summing apparatus 92. The value n, i.e. the number of considered frequency ranges, is preferably in the range of 8-20, preferably 16. The consideration of frequency ranges enables an evaluation of the size of the particles in the 2-phase mixture. Fine dust appears in high frequency ranges, while larger particles can be identified in lower frequency ranges.

The weighting and summing apparatus 92 multiplies each of the supplied frequency values by a weighting factor; the n weighting factors may be different, but preferably yield 1 in total. The weighting factors can be supplied to the weighting and summing apparatus 92 in the form of an application-specific weighting vector 94. It is particularly advantageous to make this weighting vector adjustable for the user. The weighting factors allow one to set which particle size in the 2-phase mixture is given greater weight in the visualization. By individually setting the weighting factors, the user can, for example, react to and display different types of dirt. It would also be conceivable, for example, to save various predefined and selectable weighting vectors, e.g. for the prioritization of fine dust or coarser particles.

The n weighted frequency values are then summed to form a single value and supplied to a low-pass filter 96. The low-pass filter 96 provides at its output a signal or digital values A2 which represent a smoothed form of the weighted and summed values of the weighting and summing apparatus. The low-pass filter 96 makes it possible, so to speak, to specify the inertia of the measurement.

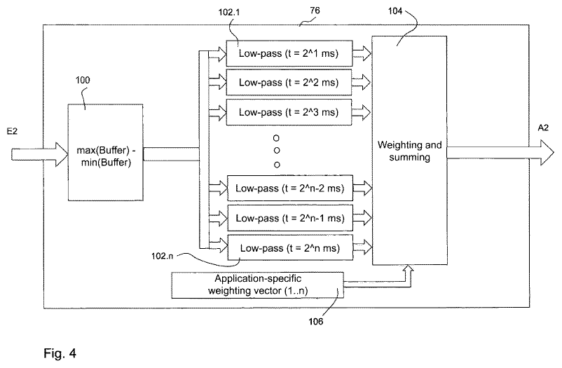

In FIG. 4, the amplitude evaluation apparatus 76 is shown in the form of a block diagram. It comprises a differentiation unit 100 which is designed to read out the values from the buffer memory 68, to identify the maximum value and the minimum value from these values, and to form the difference therefrom. This difference value is then provided at the output of the differentiation unit 100. Unlike the frequency transformation apparatus 90, the difference value is calculated for each new time window (time window that has shifted one unit further). In other words, the difference value is recalculated when a new sampled value is written into the buffer memory 68. The difference value provides information about the size of the particles in the 2-phase mixture. The difference value allows a conclusion about the largest particle in the 2-phase mixture. The difference value describes the largest particle in the 2-phase mixture, i.e. in the suction stream. If, for example, a single large piece of paper passes through the measuring space, there will be a large deflection in the measured values, i.e. the difference value will be high. If the 2-phase mixture contains only small dust particles, the measured value is small so that the difference value is also smaller than for a larger particle.

The amplitude evaluation apparatus 76 further has a number n of low-pass filters 102.1-102.n, which are provided in parallel with one another and each receive the difference value of the differentiation unit 100. The value n is an integer greater than 0, preferably 16. The low-pass filters 102.1-102.n have different time constants from each other, wherein these time constants t are increased in powers of two in the present embodiment. This means that the low-pass filter 102.1, for example, has a time constant t of 2 ms, the second low-pass filter 102.2 has a time constant t of 4 ms, the third low-pass filter 102.3 has a time constant t of 8 ms, and the last low-pass filter 102.n has a time constant t of 2\hat{ }n ms. At this point, however, it should be noted that these values are purely exemplary, but have proven to be particularly advantageous in one embodiment.

Using this series of low-pass filters 102, the temporal progression of the changing difference values can be analyzed. Therefore, the low-pass filter 102.1 with a short time constant can better represent short-term changes in the difference value than the low-pass filter 102.n, which can better represent changes in the difference value at longer time intervals. As already mentioned, a large difference value indicates that a single large particle was detected by the measuring apparatus, namely as a singular event, while a very small difference value indicates that a smaller particle is flowing through the measuring space.

The low-pass filters 102.1-102.n are supplied to a weighting and summing apparatus 104 which multiplies each value by a weighting factor and sums these weighted values to form a single value, which is provided at the output as a value A2.

The weighting factors are supplied to the weighting and summing apparatus 104 in the form of an application-specific weighting vector 106, wherein each weighting factor can be different. The sum of the weighting factors is preferably 1. As before, it is advantageous to provide the weighting vector, or a plurality of predefined weighting vectors, for the user that can be adjusted. Alternatively, it is of course also conceivable to set the weighting vector at the factory, for example after a calibration process.

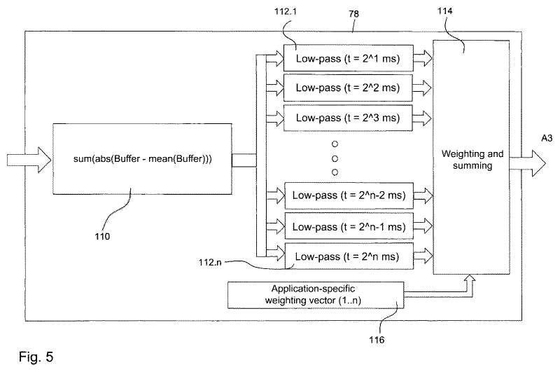

Finally, FIG. 5 shows the integral evaluation apparatus 78 as a block diagram. It comprises a summing unit 110 to which the values from the buffer memory 78 are supplied and which calculates the difference between each individual buffer value and the mean value of the values in the buffer memory 78 and sums the absolute values therefrom to form a single value. This calculation is performed with each new value that is written into the buffer memory 68.

The integral evaluation apparatus 78 further comprises a number n of low-pass filters 112.1-112.n, which are arranged in parallel with one another and to each of which the sum value of the summing unit 110 is supplied. The value n is an integer greater than 0, preferably 16. At this point, it should be noted that the number n of low-pass filters 112 does not necessarily correspond to the number n of low-pass filters 102 in the amplitude evaluation apparatus 76 or the number n of frequency ranges that are generated by the frequency transformation apparatus 90. The number n can be the same or different.

The number of n low-pass filters 112.1-112.n have different time constants t, with these time constants preferably increasing by a power of two. In other words, for example, the low-pass filter 112.1 has a time constant t of 2 ms, the second low-pass filter 112.2 has a time constant t of 4 ms, and the last low-pass filter 112.n has a time constant of 2\hat{ }n ms. Of course, these are example values, but they have proven to be particularly advantageous in practice. With the aid of these different low-pass filters, the temporal changes in the sum value at the output of the summing unit 110 can be analyzed. Changes within short time periods can be identified with the first low-pass filter 112.1, while differences in longer time intervals can be detected with the last low-pass filter 112.n. For example, if the value A3 decreases, this indicates that the degree of cleaning is increasing. In other words, the cleaning result improves since fewer and fewer particles flow through the measuring space. If the value increases, the dirt increases, i.e. the amount of particles increases.

The number of n values of the low-pass filters 112 are supplied to the weighting and summing apparatus 114. There, each value is multiplied by a weighting factor and then supplied to a summator, which calculates a total value therefrom. This value is provided at the output as a value A3.

The weighting factors are supplied to the weighting and summing apparatus 114 in the form of a weighting vector 116, the weighting vector preferably being adjustable by the user. Preferably, the sum of the weighting factors, which may be different, is 1. It is also conceivable for a plurality of different weighting vectors to be saved; the user then has the option of selecting a weighting vector. This means that the evaluation can be adjusted and adapted to different cleaning or dirt situations.

At this point it should be noted that the previously described weighting vectors 94, 106 and 116 can be different. The optimal values of the weighting vectors are usually set at the factory in the form of a calibration process.

The time sequence of digital values A1, A2 and A3 is supplied to the weighting and summing apparatus 80, which weights these values and sums them to form a value. The employed weighting factors are preferably 1 in sum and can be different. Preferably, the three weighting factors are adjustable for the user.

The summed value or the sequence of summed values is supplied to the low-pass filter 82 which operates with a time constant of, for example, 0.1 seconds. The values are smoothed by means of this low-pass filter 82 and supplied to the transmission apparatus 72. Via the digital interface 73, the values are supplied to the output apparatus 33 for representation, preferably for optical representation. The optical representation can be carried out using the display apparatus 40, which has a plurality of LEDs 42, preferably of different colors. The display can therefore show the user a high level of dirt via red LEDs and a high degree of cleaning via green LEDs. At the same time, the values can be supplied to the control apparatus 26 via the interface 73, so that, for example, the motor 14 can be controlled depending on the level of dirt.

The previously described evaluation apparatus 30 analyses the 2-phase mixture in different ways, so that conclusions can be drawn about the quality and quantity of particles in this 2-phase mixture and their change over time. This evaluation can then be presented to the user of the vacuum cleaner in different ways, with an optical display being particularly advantageous in this case.

The evaluation itself can be carried out digitally and parameterized very flexibly. This makes it possible to provide a economical circuit that can be very easily used in different types of vacuum cleaners for different applications.

For example, it is conceivable to adjust the weighting vectors in a software-based manner by using the digital interface 73. The device 30 could communicate with a computer via this interface. Via this interface 73 it would then also be possible, for example, to adjust the parameters of the operating point monitoring apparatus.

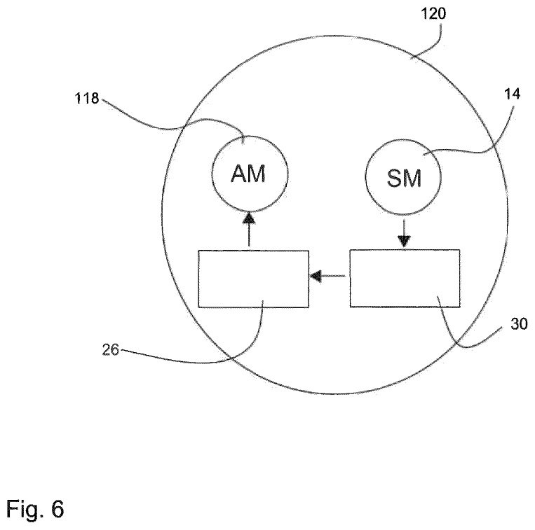

Finally, FIG. 6 shows an example of how the device can be used. A robot vacuum cleaner 120 can be seen which has the suction motor 14 and the device 30. Via the digital interface 73, the results of the evaluation are supplied to the higher-level control apparatus 26 which then controls a drive motor 118. It is therefore possible, for example, to have the robot vacuum cleaner travel more frequently into the areas of the room where the level of dirt is high. Alternatively or additionally, it can be provided that the areas of the room that have already achieved a desired level of cleaning are removed from the travel area. By means of control of the robot vacuum cleaner of this kind which depends on the degree of cleaning, energy can be saved since only the areas that still have an undesirably high level of dirt are approached and vacuumed. Due to the high accuracy of the evaluation, a good degree of cleaning can still be achieved.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “ ”e.g.,“ ” “for instance, ”such as,“ and ”like,“ and the verbs ”comprising,“ ”having,“ ”including,“ and their other verb forms, when used in conjunction with a listing of one or more components or other items, are each to be construed as open ended, meaning that the listing is not to be considered as excluding other, additional components or items. Other terms are to be construed using their broadest reasonable meaning unless they are used in a context that requires a different interpretation.

1. A device for detecting and evaluating particles, in a suction stream of a vacuum cleaner, comprising:
a light source having an infrared LED which is designed to emit a light beam along an optical path and through a measuring space;
a light sensor which is designed to receive the light beam after it has passed through the measuring space, wherein the light sensor emits an analog measurement signal;
an analog-to-digital converter that is designed to convert the analog measurement signal into time-discrete digital measured values;
a buffer memory that is designed to buffer a predefined number of measured values;
a frequency evaluation apparatus that is connected to the buffer memory and has:
a frequency transformation apparatus that is designed to break down the time-discrete measured values from the buffer memory into frequency spectrum values of a predefined number n1 of frequency ranges; and
a first weighting and summing apparatus that is designed to multiply each of the number of n1 frequency spectrum values by a first weighting value and to add the weighted n1 frequency spectrum values so that a first weighted sum value is obtained; and
a transmission apparatus that is designed to provide a digital output signal from the frequency evaluation apparatus at a digital output as a digital output value for a transmission.

2. The device according to claim 1, wherein the frequency transformation apparatus comprises a fast Fourier transform unit or a unit for carrying out the Goerzel algorithm.

3. The device according to claim 1, wherein the n1 first weighting values are adjustable.

4. The device according to claim 1, wherein a first low-pass filter is provided to which the first weighted sum value is supplied.

5. The device according to claim 1, wherein
an amplitude evaluation apparatus which is connected on an input side to the buffer memory, wherein the amplitude evaluation apparatus has:
a differentiation unit which determines the maximum and the minimum value of the values saved in the buffer memory and generates a difference value therefrom,
a first filter array with a number of n2 low-pass filters arranged in parallel with different time constants, each of which is supplied with the difference value, and
a second weighting and summing apparatus that is designed to receive the individual values from the n2 low-pass filters, to multiply each of the filtered values by a second weighting value, and to sum the weighted values to form a summed difference value.

6. The device according to claim 5, wherein the time constants of the low-pass filters in the first filter array change in powers of two.

7. The device according to claim 5, wherein the number of n2 second weighting values is adjustable.

8. The device according to claim 1, wherein
an integral evaluation apparatus which is connected on an input side to the buffer memory, wherein the integral evaluation apparatus has:
a summing unit which generates the sum of the absolute values of the difference between a value in the buffer memory and the average value of all values in the buffer memory as an integral value,
a second filter array with a number of n3 parallel low-pass filters with different time constants, each of which is supplied with the integral value, and
a third weighting and summing apparatus that is designed to receive the individual values from the n3 low-pass filters of the second filter array, to multiply each of the received values in each case by a third weighting value, and to sum the weighted values to form a summed integral value.

9. The device according to claim 8, wherein the time constants of the low-pass filters in the second filter array change in powers of two.

10. The device according to claim wherein the number of n3 third weighting values is adjustable.

11. The device according to claim 1, wherein
a fourth weighting and summing apparatus to which the values from the frequency evaluation apparatus, an amplitude evaluation apparatus and an integral evaluation apparatus are supplied, and which is designed to multiply each of the supplied values by a fourth weighting value and to sum the weighted values to form a sum output value.

12. The device according to claim 11, further comprising a low-pass filter of which an output runs to the transmission apparatus, and of which an input is connected to the fourth weighting and summing apparatus

13. The device according to claim 1, wherein the buffer memory is designed as a ring memory.

14. The device according to claim 1, wherein a first operational amplifier and a second operational amplifier are provided, wherein the first operational amplifier controls the light source and the second operational amplifier is connected on an input side to the light sensor and outputs the analog measurement signal on the output side.

15. The device according to claim 14, wherein the signal from the light sensor is supplied to the first operational amplifier, which, on the basis of this signal, controls the light source with a control signal such that the signal from the light sensor has a predefined value.

16. The device according to claim 15, wherein a monitoring unit is provided which is designed to monitor the control signal and to signal that the control signal has exceeded a predetermined, predefinable, value.

17. The device according to claim 16, wherein the control signal is supplied to a further analog-digital converter and its digital output values are monitored by the monitoring unit.

18. The device according to claim 1, wherein n1, n2 and n3 are each integers, greater than 1.

19. A method, comprising the steps of:
emitting a light beam along an optical path and through a measuring space; and
receiving the light beam with a light sensor after it has passed through the measuring space, wherein the light sensor emits an analog measurement signal;
converting the analog measurement signal into digital measured values;
buffering a predefined number of digital measured values in a buffer memory;
carrying out a frequency evaluation of the values in the buffer memory, with the steps of:
breaking down the time-discrete measured values from the buffer memory into frequency spectrum values of a predefined number n1 of frequency ranges; and
multiplying each of the number of n1 frequency spectrum values by a first weighting value and adding the weighted n1 frequency spectrum values so that a first weighted sum value is obtained; and
providing the result of the frequency evaluation as a digital output value.

20. The method according to claim 19, further comprising the steps of:
carrying out an amplitude evaluation of the measured values saved in the buffer memory, with the steps of:
determining the maximum and the minimum value of the values saved in the buffer memory and generating a difference value therefrom,
filtering the difference values through a first filter array with a number of n2 low-pass filters arranged in parallel with different time constants, and
multiplying each of the filtered values by a second weighting value and summing the weighted values to form a summed difference value.

21. The method according to claim 20, further comprising the steps of:
carrying out an integral evaluation of the measured values saved in the buffer memory, with the steps of:
summing the absolute values of the difference between a value in the buffer memory and the average value of all values in the buffer memory and outputting it as an integral value,
filtering the integral values through a second filter array with a number of n3 parallel low-pass filters with different time constants, each of which is supplied with the integral value, and
multiplying each of the filtered integral values from the n3 low-pass filters by a third weighting value and summing the weighted values to form a summed integral value.

22. A cleaning system, that is a vacuum cleaner, comprising:
a device according to claim 1,
a suction nozzle,
a suction motor;
a pipe between the suction nozzle and the suction motor, wherein the sucked-in air flows through the pipe, and a section of the pipe encloses the measuring space;
a first translucent area in the pipe section to which the light source is assigned,
a second translucent area in the tube section which is opposite the first area and to which the light sensor is assigned, wherein the optical path extends from the first area to the second area; and
a control apparatus which is connected to the transmission apparatus and receives the digital output value and uses it for control purposes, and/or an output apparatus which is connected to the transmission apparatus and receives the digital output value and uses it for optical and/or acoustic representation.

23. The cleaning system according to claim 22, wherein the control apparatus is designed to adjust the power of the suction motor on the basis of the output value.

24. The cleaning system according to claim 22 or wherein an output apparatus is provided which represents the output value visually and/or acoustically.

25. The cleaning system according to claim 22, wherein the cleaning system is a robot vacuum cleaner with a controllable drive for traveling over and cleaning a surface, wherein the output values are included in the control of the drive.
